(19) United States
(12) Patent Application Publication
(10) Pub. No.: US 2013/0170267 A1
(43) Pub. Date: Jul. 4, 2013

(54) SUPPRESSION OF CHARGE PUMP VOLTAGE DURING SWITCHING IN A MATRIX CONVERTER

(71) Applicant: GM GLOBAL TECHNOLOGY OPERATIONS LLC, Detroit, MI (US)

(72) Inventors: LATEEF A. KAJOUKE, SAN PEDRO, CA (US); TED D. PETERSON, PLAYA DEL REY, CA (US); RAY M. RANSOM, BIG BEAR CITY, CA (US)

(73) Assignee: GM GLOBAL TECHNOLOGY OPERATIONS LLC, Detroit, MI (US)

(21) Appl. No.: 13/712,801

(22) Filed: Dec. 12, 2012

Related U.S. Application Data
(60) Provisional application No. 61/582,040, filed on Dec. 30, 2011.

(51) Int. Cl. H02M 7/537

(52) U.S. Cl. CPC H02M 7/537
USPC 363/131

(57) ABSTRACT

Switches of a matrix converter are protected from potentially damaging charge-pump voltage build-up during a transition (dead) time by pulsing On (temporarily closing) any “at risk” switch during the transition (dead) time. The temporary closing of the “at risk” switch discharges any voltage build-up across a parallel coupled capacitor, which protects the at risk switch from damage or failure.

### CROSS REFERENCE TO RELATED APPLICATIONS

This application claims the benefit of U.S. Provisional Application No. 61/582,040, filed Dec. 30, 2011.

### STATEMENT REGARDING FEDERALLY SPONSORED RESEARCH OR DEVELOPMENT

This invention was made with United States Government support under Contract number DE-FC26-07NT43123, awarded by the United States Department of Energy. The United States Government has certain rights in this invention.

### TECHNICAL FIELD

The technical field relates generally to electrical systems in vehicles, and more particularly, relate to vehicle energy delivery systems employing galvanic isolation and matrix converters.

### BACKGROUND

Matrix converters may be used in electric and/or hybrid vehicles to convert direct (DC) energy into AC energy to provide power to an Electrical Power Output (EPO) for use on premises/or Power Grid usages while simultaneously achieving galvanic isolation, low harmonic distortion and high power density at a low cost. In the DC to AC power conversion process of matrix converters, a transition period (commonly referred to as a “dead time”) is provided on the primary side of the matrix converter when switching between switching one polarity to the other. During a first polarity, current flows in the transformer primary winding in one direction for half a cycle. Then there is a dead time period and current flows in the other direction for the remaining half cycle. Then the process repeats. However, even with this protection, when the matrix converter is switching from a free-wheeling mode to a power delivery mode, it is possible for a charge-pump action to develop potentially damaging voltages across the switches of the matrix converter that are in the Off state.

Accordingly, it is desirable to prevent the generation or presence of potentially damaging voltages in matrix converters. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A method is provided for suppressing charge pump voltage for protection of switches of a matrix converter. The method includes temporarily closing a particular switch of a plurality of normally open switches during a transition period between a free-wheeling mode and a power delivery mode thereby protecting the particular switch during the transition period.

A matrix converter is provided configured to operate in a free-wheeling mode and a power delivery mode. The matrix converter includes a battery coupled to a conversion module. An isolation module is coupled to the conversion module a switch matrix having a plurality of switches. A controller coupled to the conversion module and the switch matrix, and is configured to control the switch matrix to operate between the free-wheeling mode and the power delivery mode to protect a particular switch that is normally open during a transition period between the free-wheeling mode and the power delivery mode by temporarily closing the particular switch during the transition period.

### DESCRIPTION OF THE DRAWINGS

The present invention will herein after be described in conjunction with the following drawing figures, wherein like numerals denote like elements, and

FIG. 1 is an electrical schematic diagram of a electrical system suitable for employing the present disclosure in accordance to exemplary embodiments;

FIG. 2 is a simplified equivalent electrical schematic diagram of the matrix converter of FIG. 1 during an exemplary phase of operation;

FIGS. 3-4 are simplified equivalent electrical schematic diagrams of the matrix converter of FIG. 2 during a transition phase of operation;

FIGS. 5A and 5B are an illustrations of voltage waveforms developed across switches of the matrix converter of FIGS. 3-4 during a transition phase of operation;

FIG. 6 is functional block diagram of the control mechanism for the matrix converter of FIG. 1 in accordance with exemplary embodiments;

FIG. 7 is an illustration of the timing of the control waveform of the control mechanism of FIG. 6; and

FIG. 8 is a flow diagram illustrating a control method for the matrix converter of FIG. 1 in accordance with exemplary embodiments.

### DETAILED DESCRIPTION

The following detailed description is merely exemplary in nature and is not intended to limit the subject matter of the disclosure or its uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

Some of the embodiments and implementations are described above in terms of functional and/or logical block components and various processing steps. However, it should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

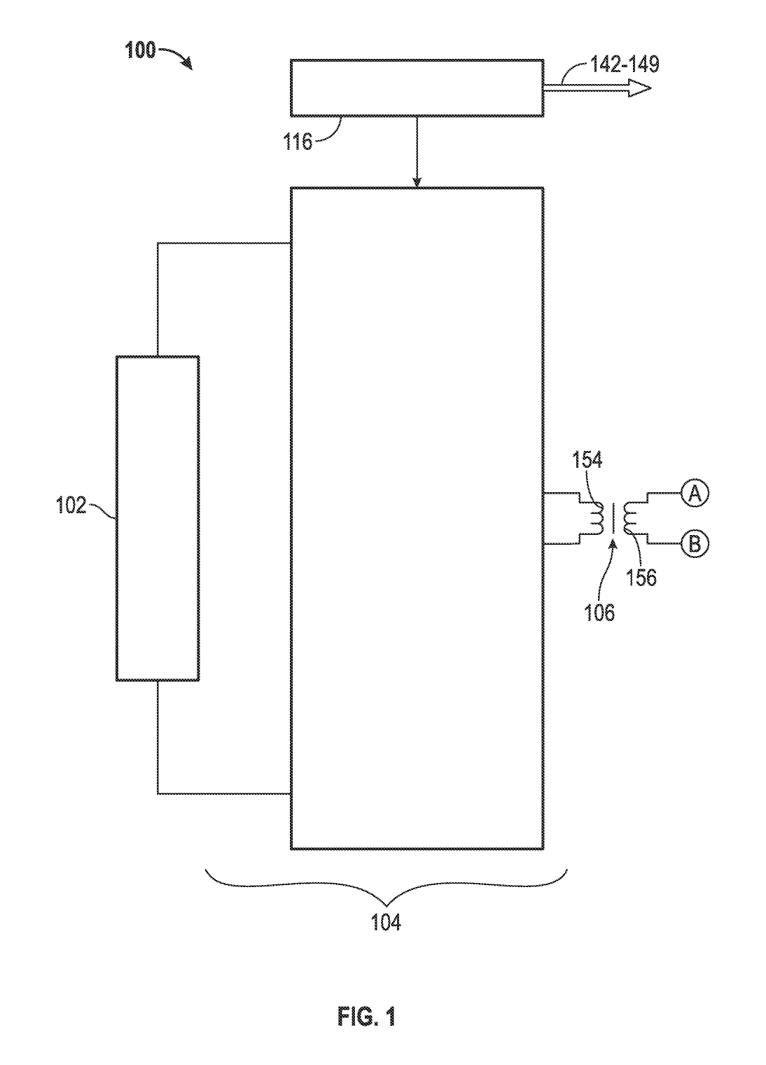

Finally, for the sake of brevity, conventional techniques and components related to vehicle mechanical and electrical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-3 are merely illustrative and may not be drawn to scale.

In this disclosure, any of the concepts presented herein can be applied generally to electric or hybrid vehicles, and as used herein, the term “vehicle” broadly refers to a non-living transport mechanism Examples of such vehicles include automobiles such as buses, cars, trucks, sport utility vehicles, vans, and mechanical rail vehicles such as trains, trams and trolleys, etc. In addition, the term “vehicle” is not limited by any specific propulsion technology such as gasoline, diesel, hydrogen or various other alternative fuels.

FIG. 1 depicts an exemplary embodiment of an electrical system 100 suitable for use in a vehicle, such as, for example, an electric and/or hybrid vehicle. The configuration and operation of such electrical systems are known and are described in co-pending, commonly assigned U.S. Pat. No. 7,599,204 and in United States Patent Publication No. 2011/0115285, each of which are incorporated by reference herein.

As illustrated in FIG. 1, the electrical system 100 includes, without limitation, a battery 102, a conversion module 104, an isolation module 106, a switch matrix 108 having an inductive element 110 and a capacitive element 112 between which an output 114 is provided, and a control module 116. In an exemplary embodiment, the control module 116 is coupled to the conversion module 104 and the switch matrix 108 and operates to control the conversion of DC energy from the battery 102 into AC energy provided at the output 114 to an AC Electrical Power Output (EPO, not shown in FIG. 1), as described in greater detail below.

It should be understood that FIG. 1 is a simplified representation of a electrical system 100 for purposes of explanation and is not intended to limit the scope or applicability of the subject matter described herein in any way. Thus, although FIG. 1 depicts direct electrical connections between circuit elements and/or terminals, alternative embodiments may employ intervening circuit elements and/or components while functioning in a substantially similar manner.

In an exemplary embodiment, the battery 102 is a rechargeable high-voltage battery pack capable of storing regenerative energy. In other embodiments, the battery 102 may comprise a fuel cell, an ultra-capacitor, or another suitable DC energy storage device. In this regard, the battery 102 may comprise the primary energy source for the electrical system 100 for an electric motor in a vehicle. In an exemplary embodiment, the battery 102 has a nominal DC voltage range from about 200 to 500 Volts DC.

In the illustrated example, the battery 102 is coupled to a conversion module 104, which converts DC energy from the battery 102 to high-frequency energy provided to the isolation module 106. In this regard, the conversion module 104 operates as an inverter. The isolation module 106 is disposed between the conversion module 104 and the switch matrix 108 and may be realized as an isolation transformer to provide galvanic isolation as discussed in more detail below.

In an exemplary embodiment, switch matrix 108 facilitates the flow of current (or energy) to an AC EPO (not shown in FIG. 1) from the isolation module 106. In the illustrated embodiment, the switch matrix 108 is realized as comprising eight switching elements 118-125, with each switching element having a diode 126-133 configured antiparallel to the respective switching element and a capacitor 134-141 configured in parallel to the switching element. In an exemplary embodiment, the switching elements 118-125, are transistors, and may be realized using any suitable semiconductor transistor switch, such as a bipolar junction transistor (e.g., an IGBT), a field-effect transistor (e.g., a MOSFET), or any other comparable device known in the art. Each of the switching elements 118-125 have a control (or activation) input 142-149 provided by the control module 116 as will be discussed below. The switches and diodes are antiparallel, meaning the switch and diode are electrically in parallel with reversed or inverse polarity. The antiparallel configuration allows for bidirectional current flow while blocking voltage unidirectionally, as will be appreciated in the art. In this configuration, the direction of current through the switches is opposite to the direction of allowable current through the respective diodes. Accordingly, for convenience, but without limitation, the switch matrix 108 may alternatively be referred to herein as a matrix conversion module or matrix converter.

In an exemplary embodiment, the inductive element 110 is realized as an inductor configured electrically in series between node 150 and a node 152 of the matrix conversion module 108. When the matrix converter 108 is functioning as a charger, the inductor 110 functions as a high-frequency inductive energy storage element during operation of the electrical system 100. In an exemplary embodiment, the capacitive element 112 is realized as a capacitor coupled in series with the inductor 110 between node 150 and node 152 of the matrix converter 108, which are cooperatively configured to provide a high frequency filter to the current flowing to the Electrical Power Output (EPO) from the output 114.

In exemplary embodiments, the isolation module 106 provides galvanic isolation between the conversion modules 104 and the matrix converter 108. In the illustrated embodiment, the isolation module 106 is realized as a high-frequency transformer, that is, a transformer designed for a particular power level at a high-frequency, such as the switching frequency (e.g., 50 kHz) of the switches 118-125 of the matrix converter 108. In an exemplary embodiment, the isolation module 106 comprises a first set of windings 154 coupled to the conversion module 104 and a second set of windings 156 coupled to the matrix converter 108. For purposes of explanation, the windings 154 may be referred to herein as comprising the primary winding stage (or primary side) and the sets of windings 156 may be referred to herein as comprising the secondary winding stage (or secondary side). The windings 154 and 156 provide inductive elements that are magnetically coupled in a conventional manner to form a transformer, as will be appreciated in the art.

The control module 116 generally represents the hardware, firmware and/or software configured to control the conversion module 104 and to modulate the switches 118-125 of the matrix converter 108 to achieve a desired power flow between the battery 102 and the AC EPO, as described in greater detail below. The control module 116 may be implemented or realized with a general purpose processor, a specific purpose processor, a microprocessor, a microcontroller, a content addressable memory, a digital signal processor, an application specific integrated circuit, a field programmable gate array, any suitable programmable logic device, discrete gate or transistor logic, discrete hardware components, or any combination thereof, designed to support and/or perform the functions described herein.

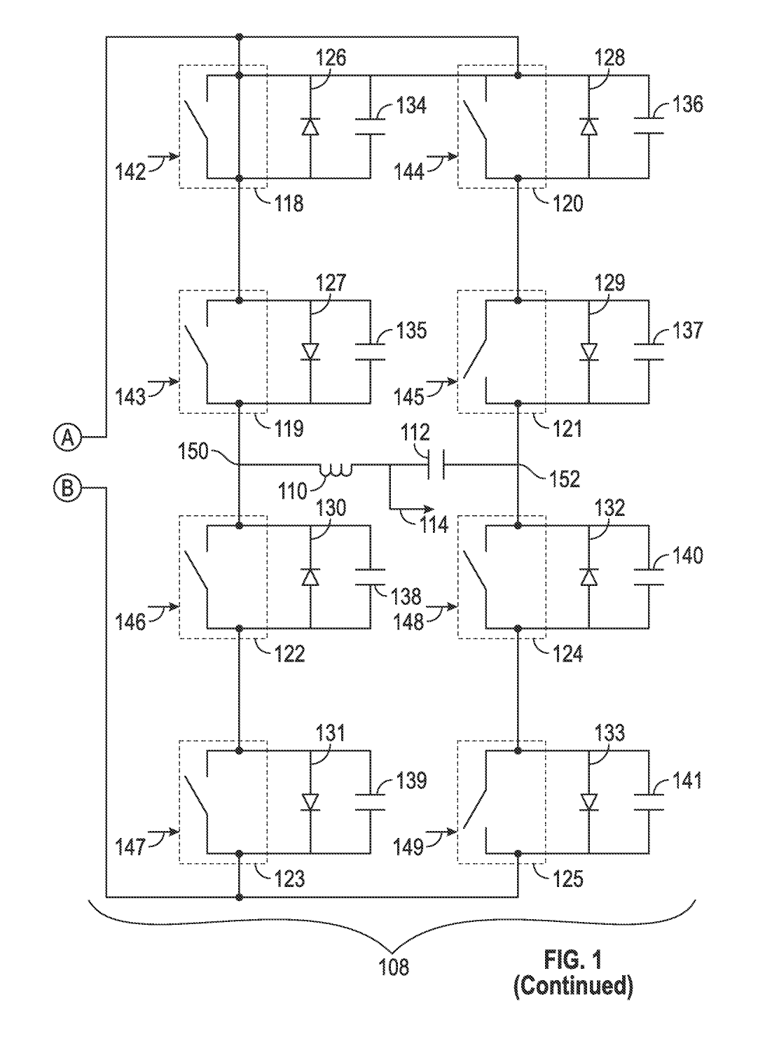

FIG. 2 is a simplified equivalent electrical schematic diagram of the matrix converter 108 of FIG. 1 during an exemplary phase of operation. In the illustrated example, an AC voltage signal 200 is provided from the isolation module 106 (of FIG. 1) to the matrix converter 108. The AC voltage signal 200 has a positive voltage 202 (+V_{dc}) and a negative voltage 204 (−V_{dc}), which is produced by the conversion module 104 in FIG. 1. In the transition between the positive voltage 202 to the negative voltage 204, a transition time 206 is provided during which the AC voltage waveform 200 is at zero volts (0V_{dc}).

According to exemplary embodiments, a transition time (commonly referred to as the “dead time”) is employed for the protection of the switches of the matrix converter 108. As used herein, “dead time” should be understood as referring to a fixed amount of time which certain switches of the matrix converter 108 may be opened (or turned Off) before other switches of the matrix converter 108 are closed (or turned On). In the illustrated embodiment, switches 118, 121, 123 and 124 comprise a positive set of switches that enable current flow from the matrix conversion module 108 in a positive direction (indicated by arrow 210), while switches 119, 120, 122 and 125 comprise a negative set of switches that enable current flow from the matrix conversion module 108 in a negative direction (opposite arrow 210) between nodes 150 and 152 of the matrix converter 108.

In the illustrated example of FIG. 2, the matrix converter 108 has switches 118-121 in an upper portion 212 the matrix converter 108 closed and switches 122-125 in a lower portion 214 the matrix converter 108 open. This switch configuration allows the upper portion 212 of the matrix converter to operate in a “freewheeling” mode. In a freewheeling mode, the control module 116 (of FIG. 1) controls the switches 118-125 of matrix converter 108 so that nodes 150 and 152 are shorted together (assuming ideal switches). One way to do this is to short the A_BUS 216 to both the 150 and 152 nodes. The voltage between nodes 150 and 152 are short-circuited together and clamped to the voltage of the A_BUS 216 (except for some small voltage drops across the switches). While operating in the freewheeling mode, power is not transferred to the output 114 because the nodes 150 and 152 are shorted together (assuming ideal switches). The control module 116 (of FIG. 1) employs the freewheeling mode to keep current flowing through the inductor between power delivery periods to avoid current interruption that may generate significant fly-back voltage that may damage or destroy the switches. It will be appreciated that by duality in other phases of operation, the lower portion 214 of the matrix converter 108 may be freewheeling by shorting the B_BUS 218 to nodes 150 and 152.

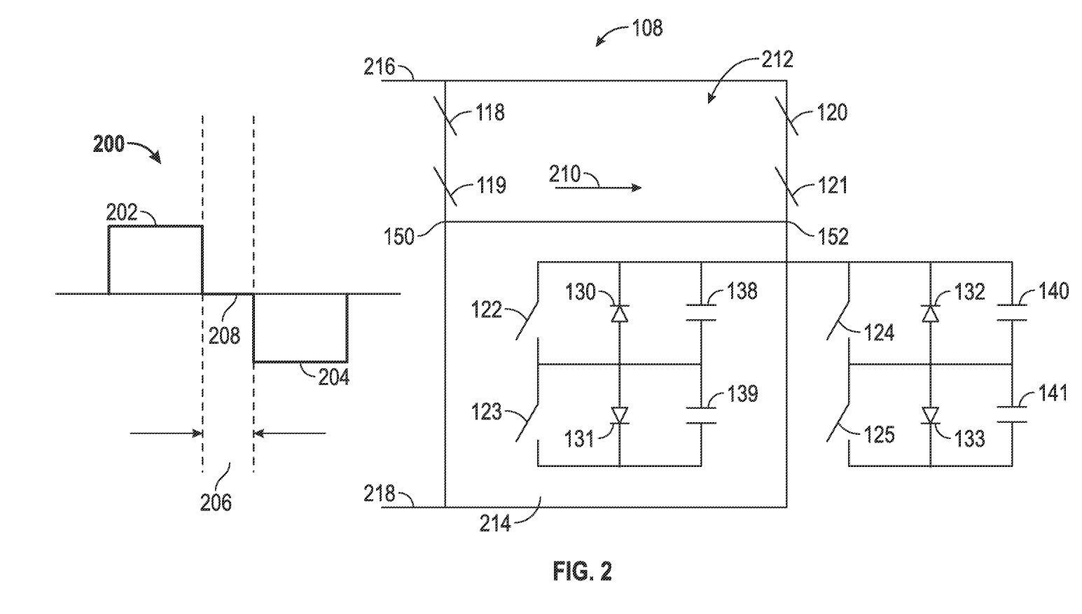

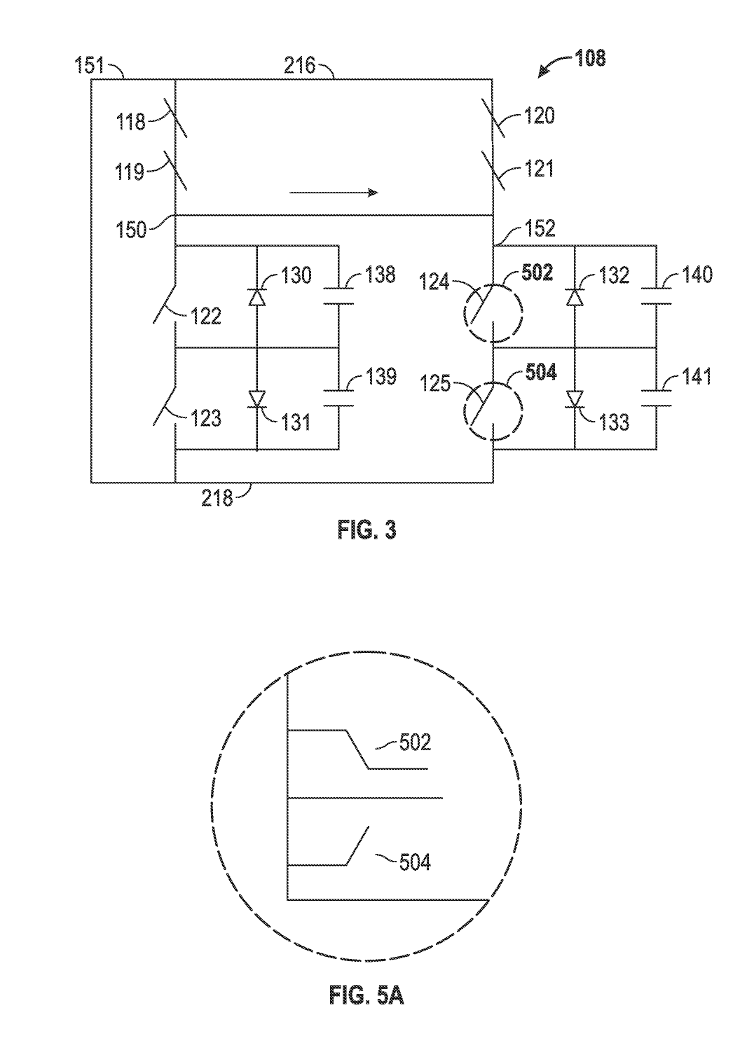

Referring now to FIGS. 3-5, simplified equivalent electrical schematic diagrams of the operation of the matrix converter 108 during the transition (dead) time 206 (of FIG. 2) during an exemplary phase of operation are shown in FIGS. 3-4 along with a voltage waveform in FIG. 5.

As the matrix converter 108 prepares to leave the freewheeling mode for the power transfer mode, the voltage across switch 124 is clamped to A_BUS voltage. As the BUS voltage 200 changes from 202 to 204 as shown in FIG. 2 zero volts are applied across the A-Bus 216 and the B-Bus 218. The time interval of zero volts is commonly referred to as the dead time. During the dead time a short circuit is applied across the A-Bus 216 and the B-Bus 218. The voltage across switch 124 is discharged via the applied short across the A-Bus 216 and the B-Bus 218 (as shown at 502 in FIG. 5A), and the capacitor 141 across switch 125 is charged as shown at 504 of FIG. 5A. As the matrix converter 108 prepares to switch to the power delivery mode during the dead time, switch 123 is turned on. The equivalent electrical circuit of the matrix converter 108 in this mode is shown in FIG. 4. During the transition (dead) time (206 of FIG. 2), 0V_{dc} is applied across the A_Bus 216 and the B_Bus 218. When switch 123 is turned on it diverts some of the inductor (110 of FIG. 1) current flow in the lower portion 214 of the matrix converter 108, which charges the capacitor 140 as shown at 506 of FIG. 5B. This may cause a charge-pump mechanism to occur across switch 124 (in this example) as shown at 508 of FIG. 5B. Depending upon the magnitude of the inductor (110 of FIG. 1) current, the voltage 504 across switch 124 could ramp up to an “avalanched” level, potentially damaging switch 124 or causing switch 124 to fail. Next switches 118 and 119 open (FIG. 4) and it will be appreciated that by principles of duality, any of the switches 118-125 could be the switch “at risk” of potential damage during other operating phases of the matrix converter 108. Exemplary embodiments of the present disclosure suppress the charge-pump voltage across any switch at risk for the protection of the matrix converter 108, and thus, the electrical system 100 (FIG. 1).

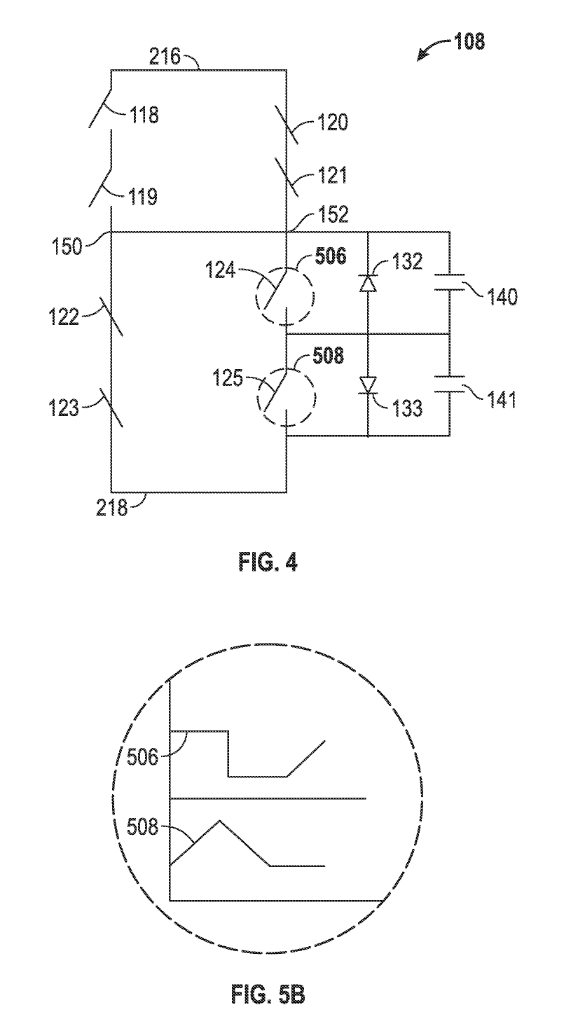

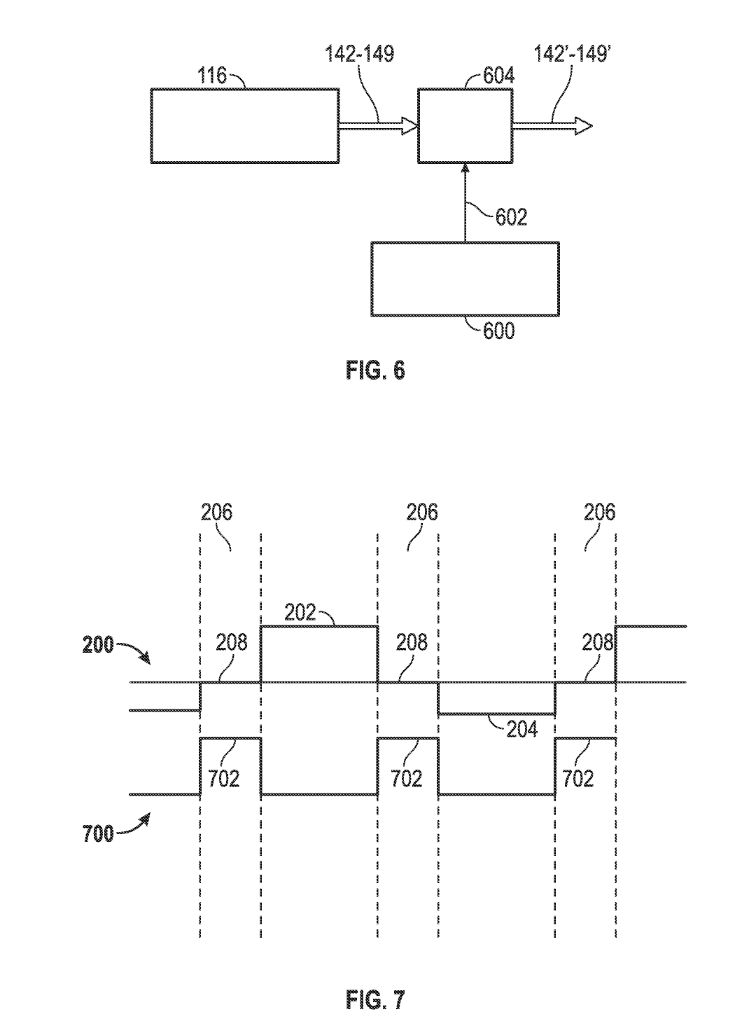

Referring now to FIGS. 6-7, a functional block diagram of the control mechanism for the matrix converter 108 of FIG. 1 is shown. According to exemplary embodiments, the present disclosure operates to apply control pulses to temporarily close any switch at risk of potential damage one or more times during the transition (dead) time. Doing so discharges the parallel capacitor preventing the charge-pump voltage build-up across the capacitor, and thus, the switch. Thus, FIG. 6 illustrates the control module 116 providing switch control 142-149 as discussed in conjunction with FIG. 1.

However, in exemplary embodiments of the present disclosure, a pulse generator 600 provides one or more control pulses 702 during the dead time 206 as illustrated in FIG. 7. In some embodiments, the pulse generator 600 is coupled via conductor 602 to a logic block 604, which logically ORs the switch control signals 142-149 with the control waveform 700 (FIG. 7) to provide control signals 142′-149′. In other embodiments, the pulse generator 600 and/or the logic block 604 could be integrated within the control module 116 as will be appreciated.

The logic OR function provided by the logic block 604 passes the control pulse 702 via one of the control signals 142′-149′ to the at risk switch even when the programming of the control module 116 would have the at risk switch Off (open). This prevents the charge-pump voltage 504 (of FIG. 5) by temporarily closing the at risk switch one or more times during the transition (dead) time 206 and discharging the capacitor parallel to the at risk switch. In the example of FIGS. 3-5, the switch 124 is “at risk” and would receive the control pulse to discharge the capacitor 140 (by shorting the capacitor via turning on switch 124) thereby protecting the switch 124 for potentially damaging voltage ramp-up due to the charge-pump mechanism.

FIG. 7 is an illustration of the timing of the control waveform 700 with reference to the AC voltage signal 200 provided from the isolation module 106 (of FIG. 1) to the matrix converter 108. As can be seen, when the AC voltage signal 200 moves between the positive voltage 202 (+V_{d}) and the negative voltage 204 (−V_{dc}), the transition (dead) time 206 provides zero volts (0V_{dc}) as the AC voltage waveform 200. During the transition (dead) time, the control waveform 700 provides one or more (one illustrated) control pulse(s) 702 that will temporarily close (turn On) the at risk switch to protect that switch as described above.

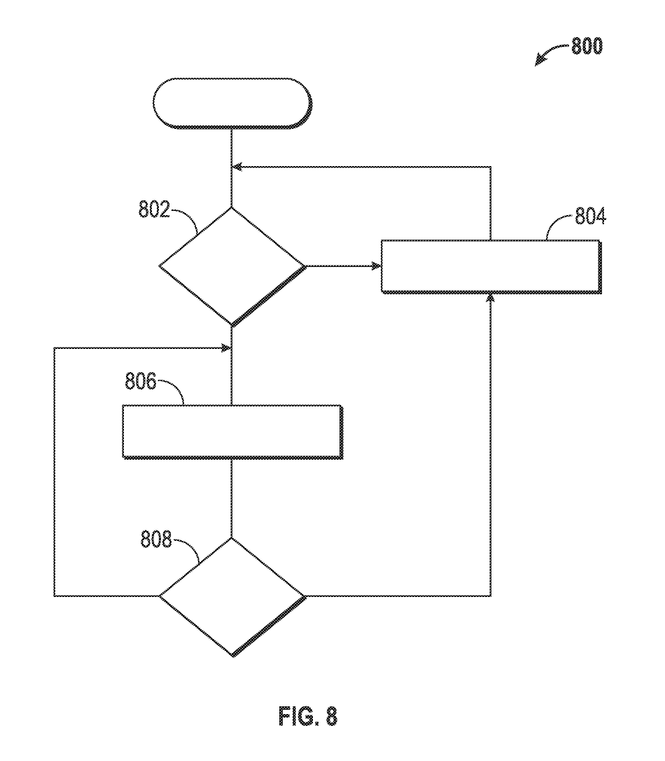

FIG. 8 is a flow diagram illustrating a control method 800 for the matrix converter of FIG. 1 in accordance with exemplary embodiments. For illustrative purposes, the following description of the method of FIG. 8 may refer to elements mentioned above in connection with FIGS. 1-7. It should also be appreciated that the method of FIG. 8 may include any number of additional or alternative tasks and that the method of FIG. 8 may be incorporated into a more comprehensive procedure or process having additional functionality not described in detail herein. Moreover, one or more of the tasks shown in FIG. 8 could be performed in a different order than that shown as long as the intended overall functionality remains intact.

The routine begins in decision 802, which determines whether the transition (dead) time (206 in FIG. 2) has begun. A negative determination results in normal operation 804 of the matrix converter (108 in FIG. 1). However, if the determination of decision 802 is that the transition (dead) time has begun, step 806 provides one or more switch control pulses (142′-149′ in FIG. 6) that include a control pulse (702 in FIG. 7) to close (turn On) any switch at risk of having a potentially damaging charge-pump voltage developed across its parallel capacitor. This discharges the parallel capacitor for the protection of the at risk switch. Next, decision 808 determines whether the transition (dead) time has elapsed. If so, normal operation ensues in step 804 and the routine 800 loops back to look for the next transition (dead) time. If the transition (dead) time has not elapsed, the routine 800 loops back to continue application of the control pulse(s) (702 in FIG. 7) in step 806 to protect the at risk switch of the matrix converter (108 in FIG. 1).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. In a matrix converter having a plurality of switches and operating in a free-wheeling mode and a power delivery mode, a method for protecting the switches during a transition period between the free-wheeling mode and the power delivery mode comprising, temporarily closing a particular switch of the plurality of switches that is normally open during the transition period thereby protecting the particular switch during the transition period.

2. The method of claim 1, wherein temporarily closing the particular switch comprises closing the particular switch during a portion of the transition period.

3. The method of claim 1, wherein temporarily closing the particular switch comprises closing the particular switch during approximately all of the transition period.

4. The method of claim 1, wherein temporarily closing the particular switch comprises applying one or more control pulses to the particular switch causing the particular switch to temporarily close during application of the one or more control pulses.

5. The method of claim 1, wherein temporarily closing the particular switch comprises temporarily closing the particular switch for a time period sufficient to discharge a capacitor in parallel with the particular switch.

6. In a matrix converter having a plurality of switches and operating in a free-wheeling mode and a power delivery mode, a method for protecting the switches during a transition period between the free-wheeling mode and the power delivery mode comprising:
determining a particular switch of the plurality of switches being at risk of a charge pump voltage accumulation across the particular switch during the transition period; and
temporarily closing the particular switch during the transition period thereby protecting the particular switch from the charge pump voltage accumulation during the transition period.

7. The method of claim 6, wherein temporarily closing the particular switch comprises closing the particular switch during a portion of the transition period.

8. The method of claim 6, wherein temporarily closing the particular switch comprises closing the particular switch during approximately all of the transition period.

9. The method of claim 6, wherein temporarily closing the particular switch comprises applying one or more control pulses to the particular switch causing the particular switch to temporarily close during application of the one or more control pulses.

10. The method of claim 6, wherein temporarily closing the particular switch comprises temporarily closing the particular switch for a time period sufficient to discharge a capacitor in parallel with the particular switch.

11. A matrix converter having a plurality of switches and configured to operate in a free-wheeling mode and a power delivery mode; comprising:
a battery;
a conversion module coupled to the battery;
an isolation module coupled to the conversion module;
a switch matrix coupled to the isolation module, the switch matrix having a plurality of switches; and
a controller coupled to the conversion module and the switch matrix, the controller configured to control the switch matrix to operate between a free-wheeling mode and a power delivery mode and configured to protect a particular switch normally open during a transition period between the free-wheeling mode and the power delivery mode by temporarily closing the particular switch during the transition period.

12. The matrix converter of claim 11, wherein the battery comprises one or more of the following group of power sources: a high-voltage battery pack, a fuel cell or an ultracapacitor .

13. The matrix converter of claim 11, wherein the conversion module comprises an inverter.

14. The matrix converter of claim 11, wherein the isolation module comprises a transformer for providing galvanic isolation between the conversion module and the switch matrix.

15. The matrix converter of claim 11, wherein the plurality of switches each have a capacitor configured in parallel with a respective one of the plurality of switches.

16. The matrix converter of claim 15, wherein temporarily closing the particular switch discharges any accumulated charge pump voltage across the capacitor configured in parallel with the particular switch.

17. The matrix converter of claim 11, wherein the controller is configured to apply one or more control pulses to the particular switch during the transition period.

18. The matrix converter of claim 11, wherein the controller is configured to determine which of the plurality of switches comprises the particular switch being at risk of charge pump voltage accumulation during the transition period.

19. The matrix converter of claim 11, wherein each the plurality of switches comprises a transistor selected from the following group of transistors: a bipolar junction transistor, a field effect transistor or IGBT.

20. The matrix converter of claims 19, wherein each of the plurality of switches are coupled in parallel to a respective diode in an anti-parallel configuration.
